(19) United States
(12) Patent Application Publication
(10) Pub. No.: US 2026/0370039 A1
(43) Pub. Date: Nov. 19, 2026

(54) NON-CONTACT POWER FEEDING DEVICE

(71) Applicant: OMRON Corporation, KYOTO (JP)

(72) Inventors: Goro NAKAO, Kyoto-shi, KYOTO (JP); Atsushi NOMURA, Kyoto-shi, KYOTO (JP); Kenichi TABATA, Kyoto-shi, KYOTO (JP)

(73) Assignee: OMRON Corporation, KYOTO (JP)

(21) Appl. No.: 19/156,903

(22) PCT Filed: Feb. 21, 2024
(86) PCT No.: PCT/JP2024/006222

§ 371 Date: Aug. 15, 2025

(30) Foreign Application Priority Data
Mar. 9, 2023 (JP) 2023-036800

(51) Int. Cl. H02J 50/12; B60L 53/122; H02J 50/80

(52) U.S. Cl. CPC H02J 50/12; H02J 50/80; B60L 53/122

(57) ABSTRACT

A power transmission device included by a non-contact power feeding device includes: a power supply circuit that supplies AC power to a transmission coil for supplying power to a power receiving device; and a control circuit. The power receiving device includes: a resonant circuit that includes a receiving coil and receives power from the transmission coil; a rectifier circuit that rectifies power output from the resonant circuit; and a resonance suppression coil that is disposed to be able to be electromagnetically coupled with the receiving coil. The power receiving device controls short-circuiting and opening of the resonance suppression coil, according to the voltage output from the rectifier circuit. The control circuit controls the voltage of AC power supplied from the power supply circuit to the transmission coil so that the duty ratio related to a period during which the resonance suppression coil is short-circuited falls in an allowable range.

### TECHNICAL FIELD

The present invention relates to a non-contact power feeding device.

### RELATED ART

Conventionally, a so-called non-contact power feeding (also called wireless power feeding) technology in which power is transmitted through space without via metal contacts or the like has been researched.

In a power feeding device (hereinafter simply called a non-contact power feeding device) utilizing the non-contact power feeding technology, when a positional relationship between a coil on a primary side (power transmission side) and a coil on a secondary side (power receiving side) varies, a degree of coupling between the two coils changes. As a result, a voltage output from a device on the power receiving side to a load circuit also fluctuates. In some cases, there is a risk that the voltage output to the load circuit may excessively rise, causing a failure in the device on the power receiving side or the load circuit or the like. Accordingly, a technology has been proposed in which energy loss is suppressed while an excessive rise in output voltage is suppressed (see Patent Document 1).

In a non-contact power transmission device disclosed in Patent Document 1, in a device on the power receiving side, a resonance suppression coil is provided that is arranged to be able to be electromagnetically coupled with a receiving coil for receiving power from a transmission coil of a device on the power transmission side. When a measured value of an output voltage obtained by rectifying power output from a resonant circuit including the receiving coil with a rectifier circuit becomes equal to or greater than a predetermined upper limit threshold, the resonance suppression coil is short-circuited and an output voltage abnormality signal is transmitted to the device on the power transmission side. In the device on the power transmission side, upon receipt of the output voltage abnormality signal, at least one of a switching frequency and voltage of AC power supplied to the transmission coil is changed.

### PRIOR-ART DOCUMENTS

### Patent Documents

Patent Document 1: Japanese Patent Laid-open No. 2019-176565

### SUMMARY OF THE INVENTION

### Problems to be Solved by the Invention

In the above technology, in order to maintain a so-called constant voltage output operation in which the output voltage from the device on the power receiving side is kept substantially constant even if a resistance value of a load circuit connected to the device on the power receiving side fluctuates, it is required to control both the frequency and voltage of AC power supplied to the transmission coil. Hence, in an operating environment where the positional relationship between the transmission coil and the receiving coil frequently varies even during power transmission, there is a risk that the frequency and voltage of AC power supplied to the transmission coil may become out of control. As a result, the output voltage may not be able to be kept constant and it may be difficult to maintain sufficient power transmission efficiency.

Accordingly, the present invention aims to provide a non-contact power feeding device that makes it possible to improve power transmission efficiency while keeping an output voltage on the power receiving side within a constant range.

### Means for Solving the Problems

As one embodiment of the present invention, a non-contact power feeding device is provided including a power transmission device and a power receiving device to which power is transmitted from the power transmission device in a non-contact manner. In the non-contact power feeding device, the power transmission device includes: a transmission coil, supplying power to the power receiving device; a power supply circuit, supplying AC power to the transmission coil; a first communication unit, capable of communicating with the power receiving device; and a control circuit, controlling a voltage of AC power supplied from the power supply circuit to the transmission coil. The power receiving device includes: a resonant circuit, including a receiving coil and a resonant capacitor connected to the receiving coil, the resonant circuit receiving power from the transmission coil by resonating with current flowing through the transmission coil of the power transmission device; a rectifier circuit, rectifying power received via the resonant circuit; a voltage detection circuit, measuring an output voltage of power output from the rectifier circuit; a resonance suppression coil, arranged to be able to be electromagnetically coupled with the receiving coil; a switch circuit, connected to the resonance suppression coil and capable of switching between short-circuiting and opening of the resonance suppression coil; a second communication unit, capable of communicating with the power transmission device; and a switch control circuit, controlling the switch circuit to short-circuit the resonance suppression coil in response to a measured value of the output voltage becoming equal to or greater than a predetermined upper limit threshold, controlling the switch circuit to open the resonance suppression coil in response to the measured value of the output voltage becoming equal to or less than a predetermined lower limit threshold that is lower than the predetermined upper limit threshold, obtaining a duty ratio related to a period during which the resonance suppression coil is short-circuited, and causing the second communication unit to transmit the duty ratio. The control circuit of the power transmission device controls the voltage of AC power supplied from the power supply circuit to the transmission coil so that the duty ratio received via the first communication unit falls within a predetermined allowable range.

By having such a configuration, the non-contact power feeding device can be improved in power transmission efficiency while making it possible to keep the output voltage on the power receiving side within a constant range.

Preferably, the power transmission device of the non-contact power feeding device further includes: a first capacitor, connected between the power supply circuit and one end of the transmission coil; a first coil, connected between the power supply circuit and one end or the other end of the transmission coil and the power supply circuit; and a second capacitor, having one end connected to the first capacitor and the other end connected to the other end of the transmission coil. Preferably, a frequency of AC power supplied from the power supply circuit to the transmission coil is set to be included in a predetermined frequency range that includes a resonant frequency of the resonant circuit of the power receiving device.

By having such a configuration, in the non-contact power feeding device, even if a degree of coupling between the transmission coil and receiving coil varies, a constant voltage output operation can be performed.

Preferably, in a case where a period during which the resonance suppression coil of the power receiving device is opened is longer than a predetermined threshold, the control circuit of the power transmission device controls the power supply circuit to raise the voltage of AC power supplied from the power supply circuit to the transmission coil; in a case where the duty ratio is greater than an upper limit of the predetermined allowable range and the period during which the resonance suppression coil is opened is equal to or shorter than the predetermined threshold, the control circuit of the power transmission device controls the power supply circuit to lower the voltage of AC power supplied from the power supply circuit to the transmission coil.

By having such a configuration, in the non-contact power feeding device, the output voltage can be maintained within a constant range, and the power consumed during short-circuiting of the resonance suppression coil can be reduced.

Preferably, the power receiving device further includes a thermometer that measures a temperature of the switch circuit. Preferably, when the temperature measured by the thermometer exceeds a predetermined temperature threshold, the control circuit lowers the voltage of AC power supplied from the power supply circuit to the transmission coil to a predetermined standby voltage.

By having such a configuration, in the non-contact power feeding device, an excessive increase in a heat generation amount in the power receiving device can be prevented.

Furthermore, preferably, the power receiving device is mounted on a moving body, and the transmission coil of the power transmission device is installed on a movement path of the moving body.

By having such a configuration, in the non-contact power feeding device, power can be fed to the moving body during movement of the moving body along the movement path.

### BRIEF DESCRIPTION OF THE DRAWINGS

FIG. 1 is a schematic configuration diagram of a non-contact power feeding device according to one embodiment of the present invention.

FIG. 2 is a diagram showing an example of a simulation result of a frequency characteristic of an output voltage of the non-contact power feeding device according to the present embodiment.

FIG. 3 is a diagram showing an example of a relationship between output voltage, short-circuiting and opening of a resonance suppression coil, input voltage of AC power supplied to a transmission coil, and current flowing through a switch circuit.

FIG. 4 is a diagram showing an example of a waveform of current flowing through a switching element of an inverter when the resonance suppression coil is short-circuited.

FIG. 5 is an operation flowchart of control of input voltage.

FIG. 6 is a diagram showing an example of a relationship between output voltage, short-circuiting and opening of the resonance suppression coil, input voltage, and current flowing through the switch circuit in the case where a load of a load circuit has fluctuated.

FIG. 7 is a system overview diagram in the case where the non-contact power feeding device according to an embodiment or a modification is utilized as a power supply system for a moving body.

### DESCRIPTION OF THE EMBODIMENTS

Hereinafter, a non-contact power feeding device according to one embodiment of the present invention will be described with reference to the drawings. In the non-contact power feeding device, a device (hereinafter simply called a power receiving device) on a power receiving side includes, along with a coil (hereinafter called a receiving coil) for power reception, a coil (hereinafter simply called a resonance suppression coil) for resonance suppression that is provided to be able to be electromagnetically coupled with the receiving coil. When an output voltage from a rectifier circuit provided in the power receiving device becomes equal to or greater than a predetermined upper limit threshold, the power receiving device short-circuits the resonance suppression coil and changes a resonance condition of a resonant circuit including the receiving coil, thereby lowering the output voltage. Conversely, when the output voltage becomes equal to or less than a predetermined lower limit threshold, the power receiving device opens the resonance suppression coil, thereby restoring the resonance condition of the resonant circuit to its original state and raising the output voltage. Furthermore, the power receiving device measures a duty ratio (hereinafter sometimes called a duty ratio related to short-circuiting of the resonance suppression coil, or a duty ratio related to a period during which the resonance suppression coil is short-circuited) which is a ratio of an ON period during which the resonance suppression coil is short-circuited to a repetition cycle of short-circuiting and opening of the resonance suppression coil. The power receiving device notifies the duty ratio to a device (hereinafter simply called a power transmission device) on a power transmission side. The power transmission device controls a voltage of AC power supplied to a coil (hereinafter called a transmission coil) for power transmission so that the notified duty ratio falls in a predetermined allowable range, thereby reducing loss during short-circuiting of the resonance suppression coil. Accordingly, the non-contact power feeding device makes it possible to improve power transmission efficiency while keeping the output voltage on the power receiving side within a constant range.

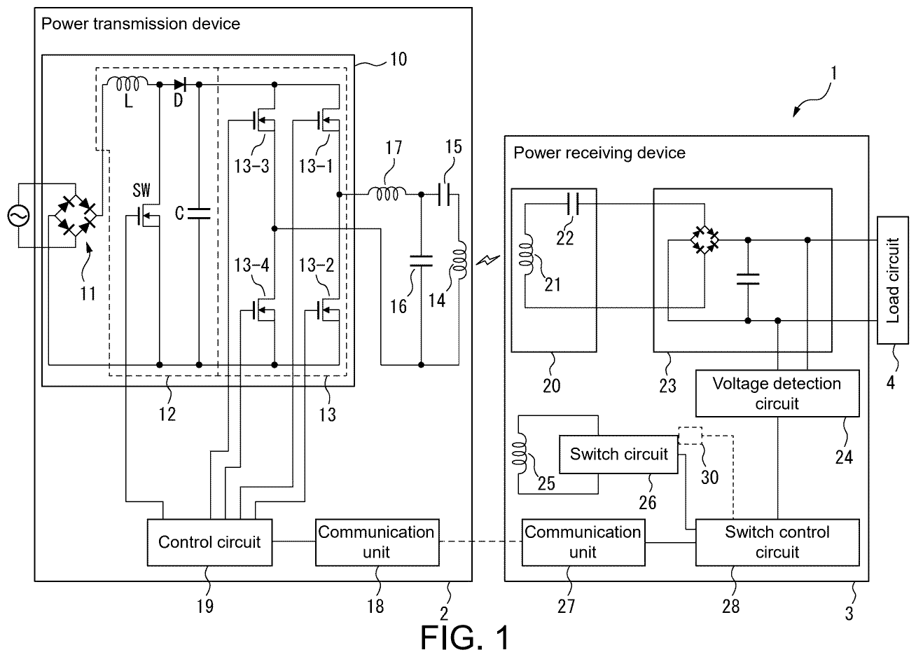

FIG. 1 is a schematic configuration diagram of a non-contact power feeding device according to one embodiment of the present invention. As shown in FIG. 1, a non-contact power feeding device 1 includes a power transmission device 2, and a power receiving device 3 to which power is transmitted from the power transmission device 2 in a non-contact manner via space. The power transmission device 2 includes a power supply circuit 10, a transmission coil 14, a first capacitor 15, a second capacitor 16, a first coil 17, a communication unit 18, and a control circuit 19. On the other hand, the power receiving device 3 includes a resonant circuit 20 that includes a receiving coil 21 and a resonant capacitor 22, a rectifier smoothing circuit 23, a voltage detection circuit 24, a resonance suppression coil 25, a switch circuit 26, a communication unit 27, and a switch control circuit 28. The power receiving device 3 is connected to a load circuit 4. Power received by the power receiving device 3 and converted into DC is output to the load circuit 4.

First, the power transmission device 2 is described.

The power supply circuit 10 supplies AC power having a predetermined drive frequency and an adjustable voltage to the transmission coil 14. For this purpose, the power supply circuit 10 includes a full-wave rectifier circuit 11, a power factor correction circuit 12, and an inverter 13.

The full-wave rectifier circuit 11 supplies power having a predetermined pulsating voltage. For this purpose, the full-wave rectifier circuit 11 includes four diodes connected in a bridge configuration, and is connected to a commercial AC power source. The full-wave rectifier circuit 11 rectifies AC power supplied from the AC power source and converts the AC power into power having a pulsating voltage, and outputs the power to the power factor correction circuit 12.

The power factor correction circuit 12 converts the power output from the full-wave rectifier circuit 11 into DC power having a voltage according to control from the control circuit 19 and outputs the DC power. Accordingly, a DC power source is configured by the AC power source, the full-wave rectifier circuit 11, and the power factor correction circuit 12.

A configuration of the power factor correction circuit 12 can be the same as any of various power factor correction circuits capable of adjusting an output voltage by control from the control circuit 19. In the present embodiment, the power factor correction circuit 12 includes: a coil, connected in series at one end to a positive output terminal of the full-wave rectifier circuit 11; and a diode, connected between the other end of the coil and the inverter 13 so that a direction from the coil toward the inverter 13 is the forward direction. The power factor correction circuit 12 further includes: a switching element, having one end connected between the coil and the diode and the other end connected to a negative output terminal of the full-wave rectifier circuit 11; and a smoothing capacitor, connected in parallel with the switching element with the diode therebetween. By controlling an on/off duty ratio of the switching element, the control circuit 19 controls a voltage output from the power factor correction circuit 12.

The inverter 13 converts the DC power output from the power factor correction circuit 12 into AC power having a drive frequency corresponding to a switching cycle of on/off of switching elements 13-1 to 13-4. The inverter 13 outputs the AC power to the transmission coil 14 via the first capacitor 15, the second capacitor 16, and the first coil 17.

For this purpose, the inverter 13 includes the four switching elements 13-1 to 13-4. Each of the four switching elements 13-1 to 13-4 can be, for example, an n-channel MOSFET. The inverter 13 is configured as a so-called full-bridge circuit. That is, the switching element 13-1 and the switching element 13-2 are connected in series between the positive output terminal and the negative output terminal of the full-wave rectifier circuit 11 via the power factor correction circuit 12. In the present embodiment, the switching element 13-1 is connected to the positive side of the full-wave rectifier circuit 11, while the switching element 13-2 is connected to the negative side of the full-wave rectifier circuit 11. A drain terminal of the switching element 13-1 is connected to the positive output terminal of the full-wave rectifier circuit 11 via the power factor correction circuit 12, and a source terminal of the switching element 13-1 is connected to a drain terminal of the switching element 13-2. A source terminal of the switching element 13-2 is connected to the negative output terminal of the full-wave rectifier circuit 11 via the power factor correction circuit 12. Furthermore, the source terminal of the switching element 13-1 and the drain terminal of the switching element 13-2 are connected to one end of the transmission coil 14 via the first coil 17 and the first capacitor 15.

Similarly, among the four switching elements 13-1 to 13-4, the switching element 13-3 and the switching element 13-4 are connected in parallel with the switching element 13-1 and the switching element 13-2, and in series between the positive output terminal and the negative output terminal of the full-wave rectifier circuit 11 via the power factor correction circuit 12. The switching element 13-3 is connected to the positive side of the full-wave rectifier circuit 11, while the switching element 13-4 is connected to the negative side of the full-wave rectifier circuit 11. A drain terminal of the switching element 13-3 is connected to the positive output terminal of the full-wave rectifier circuit 11 via the power factor correction circuit 12, and a source terminal of the switching element 13-3 is connected to a drain terminal of the switching element 13-4. A source terminal of the switching element 13-4 is connected to the negative output terminal of the full-wave rectifier circuit 11 via the power factor correction circuit 12. Furthermore, the source terminal of the switching element 13-3 and the drain terminal of the switching element 13-4 are connected to the other end of the transmission coil 14.

A gate terminal of each of the switching elements 13-1 to 13-4 is connected to the control circuit 19. Furthermore, the gate terminal of each switching element may be connected to the source terminal of the each switching element via a resistor, in order to ensure that the switching element turns on when a voltage that turns it on is applied. Each switching element is alternately switched on/off according to a control signal from the control circuit 19. In the present embodiment, the switching elements are alternately switched on/off so that, while the switching element 13-1 and the switching element 13-4 are on, the switching element 13-2 and the switching element 13-3 are off; conversely, while the switching element 13-2 and the switching element 13-3 are on, the switching element 13-1 and the switching element 13-4 are off. Accordingly, the DC power supplied from the power factor correction circuit 12 is converted into the AC power having a drive frequency corresponding to a switching cycle of on/off of each switching element, and is supplied to the transmission coil 14.

The inverter 13 is not limited to the above embodiment. For example, the inverter 13 may be configured as a half-bridge circuit in which two switching elements are connected in a half-bridge shape.

The first coil 17 is connected in series between the inverter 13 and the transmission coil 14 together with the first capacitor 15. That is, one end of the first coil 17 is connected to one of two output terminals of the inverter 13, that is, between the source terminal of the switching element 13-1 and the drain terminal of the switching element 13-2, and the other end of the first coil 17 is connected to one end of the first capacitor 15. The other end of the first capacitor 15 is connected to one end of the transmission coil 14. The first coil 17 is preferably arranged so as not to be electromagnetically coupled with the transmission coil 14 and each coil included in the power receiving device 3.

Furthermore, the second capacitor 16 has one end connected between the other end of the first coil 17 and one end of the first capacitor 15, and has the other end connected to the other end of the transmission coil 14 and the other output terminal of the inverter 13, that is, the source terminal of the switching element 13-3 and the drain terminal of the switching element 13-4.

By providing the first capacitor 15, the second capacitor 16, and the first coil 17 as described above, a phase delay of a current flowing through the transmission coil 14 with respect to a phase of a voltage supplied to the transmission coil 14 is adjusted to reduce switching loss in each switching element of the inverter 13. Furthermore, the non-contact power feeding device 1 is able to perform a constant voltage output operation regardless of a degree of coupling between the transmission coil 14 and the receiving coil 21.

The connection position of the first coil 17 is not limited to the above example. The first coil 17 may be connected to a side opposite to a side to which the first capacitor 15 is connected between the transmission coil 14 and the inverter 13. That is, the first coil 17 may be connected between one end of the transmission coil 14 opposite to the one end to which the first capacitor 15 is connected, and the switching element 13-3 and the switching element 13-4 of the inverter 13.

The transmission coil 14 transmits AC power supplied from the inverter 13 of the power supply circuit 10 via the first coil 17 and the first capacitor 15 to the resonant circuit 20 of the power receiving device 3 via space.

The communication unit 18 is an example of a first communication unit, and is configured to be capable of wireless communication with the communication unit 27 of the power receiving device 3. Each time the communication unit 18 receives a wireless signal from the communication unit 27, the communication unit 18 extracts, from the wireless signal, duty ratio information indicating a duty ratio related to short-circuiting of the resonance suppression coil 25 of the power receiving device 3, and outputs the duty ratio information to the control circuit 19. For this purpose, the communication unit 18 includes, for example, an antenna that receives a wireless signal in accordance with a predetermined wireless communication standard, and a communication circuit that demodulates the wireless signal. The predetermined wireless communication standard can be, for example, ISO/IEC 15693, ZigBee (registered trademark), or Bluetooth (registered trademark).

The control circuit 19 includes, for example, a nonvolatile memory circuit and a volatile memory circuit, an arithmetic circuit, an interface circuit for connecting to other circuits, and a drive circuit for outputting the control signal to each switching element. Each time the control circuit 19 receives the duty ratio information from the communication unit 18, the control circuit 19 controls a voltage of AC power supplied from the power supply circuit 10 to the transmission coil 14 according to the duty ratio information. Details of voltage control by the control circuit 19 will be described later.

Furthermore, the control circuit 19 controls on/off of the four switching elements 13-1 to 13-4 of the inverter 13 so that a frequency of AC power supplied from the inverter 13 to the transmission coil 14 becomes a predetermined drive frequency. That is, the control circuit 19 controls each switching element, so that the set of the switching element 13-1 and the switching element 13-4 and the set of the switching element 13-2 and the switching element 13-3 alternately turn on, and, within one cycle corresponding to the predetermined drive frequency, a period during which the set of the switching element 13-1 and the switching element 13-4 is on and a period during which the set of the switching element 13-2 and the switching element 13-3 is on become equal. In order to prevent the respective sets of switching elements from turning on at the same time and causing a short circuit of the AC power source, the control circuit 19 may provide a dead time during which all switching elements are off when each set of switching elements is switched on/off.

Next, the power receiving device 3 is described.

The resonant circuit 20 is an LC resonant circuit in which the receiving coil 21 and the resonant capacitor 22 are connected in series. One end of the receiving coil 21 included in the resonant circuit 20 is connected to one input terminal of the rectifier smoothing circuit 23 via the resonant capacitor 22. The other end of the receiving coil 21 is connected to the other input terminal of the rectifier smoothing circuit 23.

By resonating with AC current flowing through the transmission coil 14 of the power transmission device 2, the receiving coil 21, together with the resonant capacitor 22, receives power from the transmission coil 14. The receiving coil 21 outputs the received power to the rectifier smoothing circuit 23 via the resonant capacitor 22. For this purpose, the inductance of the receiving coil 21 and the capacitance of the resonant capacitor 22 are set so that a resonant frequency of the resonant circuit 20 becomes substantially equal to the drive frequency of AC current flowing through the transmission coil 14. The number of turns of the receiving coil 21 and the number of turns of the transmission coil 14 of the power transmission device 2 may be the same or may be different.

The resonant capacitor 22 is connected in series with the receiving coil 21. That is, the resonant capacitor 22 is connected at one end thereof to one end of the receiving coil 21, and connected at the other end thereof to the rectifier smoothing circuit 23. The resonant capacitor 22 outputs the power received by resonating together with the receiving coil 21 with respect to current flowing through the transmission coil 14 to the rectifier smoothing circuit 23.

The rectifier smoothing circuit 23 is an example of a rectifier circuit, and includes: a full-wave rectifier circuit, connected to the resonant circuit 20 and including four diodes connected in a bridge configuration; and a smoothing capacitor, provided on an output side of the full-wave rectifier circuit. The rectifier smoothing circuit 23 rectifies and smooths AC power output from the resonant circuit 20, and converts the AC power into DC power. The rectifier smoothing circuit 23 outputs the DC power to the load circuit 4.

The voltage detection circuit 24 measures a voltage between both terminals on an output side of the rectifier smoothing circuit 23, that is, a voltage output from the power receiving device 3 to the load circuit 4, at predetermined cycles. The voltage detection circuit 24 can be, for example, any of various known voltage detection circuits capable of detecting DC voltage. The voltage detection circuit 24 outputs a voltage detection signal indicating a measured value of the output voltage to the switch control circuit 28.

The resonance suppression coil 25 is provided to be able to be electromagnetically coupled with the receiving coil 21 of the resonant circuit 20. For example, the resonance suppression coil 25 and the receiving coil 21 are wound around the same core wire. The number of turns of the receiving coil 21 and the number of turns of the resonance suppression coil 25 may be the same or may be different. Both ends of the resonance suppression coil 25 are respectively connected to the switch circuit 26. When the resonance suppression coil 25 is short-circuited by the switch circuit 26, the resonance suppression coil 25 is electromagnetically coupled with the receiving coil 21, and the resonant frequency of the resonant circuit 20 changes. Hence, even if the output voltage from the resonant circuit 20 excessively rises, since power transmitted from the power transmission device 2 to the power receiving device 3 decreases due to short-circuiting of the resonance suppression coil 25, the output voltage from the resonant circuit 20 also falls.

On the other hand, when the switch circuit 26 opens both ends of the resonance suppression coil 25, the resonance suppression coil 25 stops participating in resonance between the transmission coil 14 and the receiving coil 21, and stops affecting power transmission from the power transmission device 2 to the power receiving device 3.

The switch circuit 26 is connected to both ends of the resonance suppression coil 25, and switches the resonance suppression coil 25 between short-circuiting and opening according to a control signal from the switch control circuit 28. That is, the switch circuit 26 short-circuits the resonance suppression coil 25 while receiving the control signal to turn on from the switch control circuit 28. On the other hand, the switch circuit 26 opens both ends of the resonance suppression coil 25 while receiving the control signal to turn off from the switch control circuit 28.

The switch circuit 26 includes, for example, a relay circuit. When the switch control circuit 28 turns on the relay circuit, the resonance suppression coil 25 is short-circuited. On the other hand, when the switch control circuit 28 turns off the relay circuit, both ends of the resonance suppression coil 25 are opened.

The switch circuit 26 may include two n-channel type MOSFETs connected in series between both ends of the resonance suppression coil 25. In this case, the two MOSFETs are arranged so that their source terminals are connected to each other, and their drain terminals are respectively connected to both ends of the resonance suppression coil 25. The gate terminals of the two MOSFETs are connected to the switch control circuit 28. When a relatively high voltage corresponding to the control signal to turn on is applied from the switch control circuit 28 to the gate terminals of the two MOSFETs, since it becomes possible for current to flow between the source and drain of each MOSFET, the resonance suppression coil 25 is short-circuited. On the other hand, when a relatively low voltage corresponding to the control signal to turn off is applied from the switch control circuit 28 to the gate terminals of the two MOSFETs, current stops flowing between the source and drain of each MOSFET, and body diodes of the two MOSFETs are oriented in opposite directions to each other. Thus, current does not flow through the respective body diodes. Hence, both ends of the resonance suppression coil 25 are opened.

The two MOSFETs may also be arranged so that their drain terminals are connected to each other, and their source terminals are respectively connected to both ends of the resonance suppression coil 25. In this example as well, when a relatively high voltage corresponding to the control signal to turn on is applied from the switch control circuit 28 to the gate terminals of the two MOSFETs, the resonance suppression coil 25 is short-circuited. On the other hand, when a relatively low voltage corresponding to the control signal to turn off is applied from the switch control circuit 28 to the gate terminals of the two MOSFETs, both ends of the resonance suppression coil 25 are opened.

The communication unit 27 is an example of a second communication unit, and is configured to be capable of wireless communication with the communication unit 18 of the power transmission device 2. Each time the communication unit 27 receives the duty ratio information indicating the duty ratio related to short-circuiting of the resonance suppression coil 25 from the switch control circuit 28, the communication unit 27 generates a wireless signal including the duty ratio information, and transmits the generated wireless signal. For this purpose, the communication unit 27 includes a communication circuit that generates a wireless signal in accordance with the wireless communication standard to which the communication unit 18 conforms, and an antenna that outputs the wireless signal.

The switch control circuit 28 controls on/off of the switch circuit 26 based on the measured value of the output voltage received from the voltage detection circuit 24 at predetermined cycles, and obtains the duty ratio related to short-circuiting of the resonance suppression coil 25. For this purpose, the switch control circuit 28 includes, for example: a memory circuit, storing an upper limit threshold and a lower limit threshold of an output voltage; an arithmetic circuit, for comparing the measured value of the output voltage with those thresholds and calculating the duty ratio; and a control circuit, for controlling on/off of the switch circuit 26.

When the measured value of the output voltage becomes equal to or greater than a predetermined upper limit threshold, the switch control circuit 28 turns on the switch circuit 26 and short-circuits the resonance suppression coil 25. Accordingly, the switch control circuit 28 lowers the output voltage by changing the resonant frequency of the resonant circuit 20. On the other hand, when the measured value of the output voltage becomes equal to or less than a predetermined lower limit threshold, the switch control circuit 28 turns off the switch circuit 26 and opens the resonance suppression coil 25. Accordingly, the switch control circuit 28 raises the output voltage by restoring the resonant frequency of the resonant circuit 20 to its original state. By controlling on/off of the switch circuit 26 in this way, short-circuiting and opening of the resonance suppression coil 25 are repeated, and the output voltage is adjusted to fall in an allowable range defined by the lower limit threshold and the upper limit threshold. The upper limit threshold is set to, for example, a value obtained by multiplying an upper limit value of the output voltage that does not cause problems in an operation of the load circuit 4 by a safety factor (for example, 0.9 to 0.97) less than 1. The lower limit threshold is set to a value lower than the upper limit threshold and obtained by multiplying a lower limit value of the output voltage that does not cause problems in an operation of the load circuit 4 by a safety factor (for example, 1.03 to 1.1) greater than 1.

Furthermore, at predetermined cycles, the switch control circuit 28 measures a cycle of short-circuiting and opening of the resonance suppression coil 25, that is, a repetition cycle from a timing at which the switch circuit 26 is temporarily turned on until the switch circuit 26 is turned on again next time, an ON period during which the switch circuit 26 is on, and an OFF period during which the switch circuit 26 is off. Based on a result of the measurement, the switch control circuit 28 calculates a ratio of the ON period to the repetition cycle, that is, the duty ratio related to short-circuiting of the resonance suppression coil 25. The switch control circuit 28 generates duty ratio information indicating the duty ratio related to short-circuiting of the resonance suppression coil 25 and the OFF period. The switch control circuit 28 outputs the generated duty ratio information to the communication unit 27.

Output voltage characteristics of the non-contact power feeding device 1 will be described below.

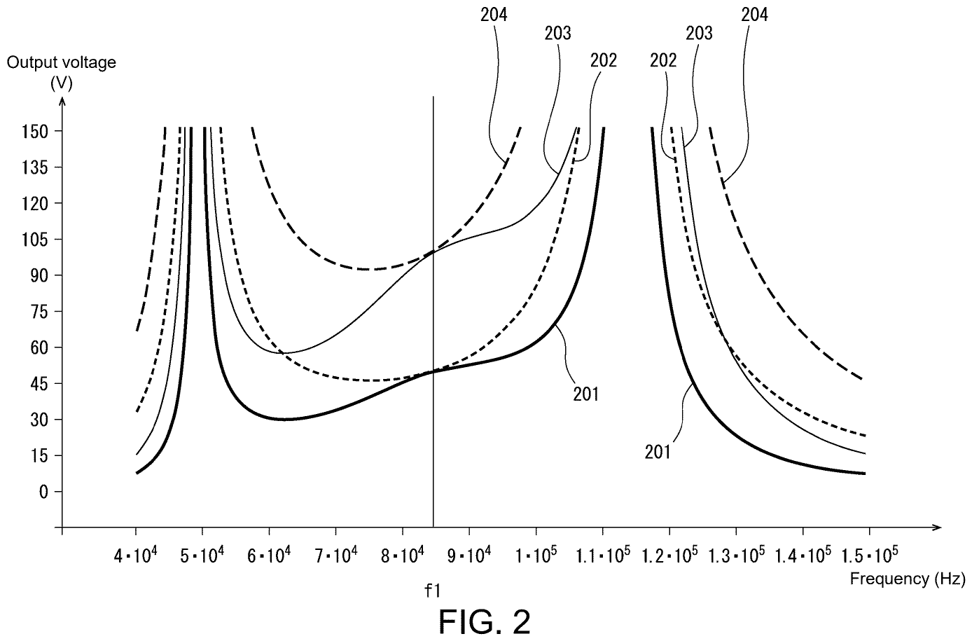

FIG. 2 is a diagram showing an example of a simulation result of a frequency characteristic of an output voltage of the non-contact power feeding device 1 according to the present embodiment. In FIG. 2, the horizontal axis represents frequency, and the vertical axis represents output voltage. In this simulation, the resonance suppression coil 25 of the power receiving device 3 is opened and does not affect power transmission. The capacitance of the first capacitor 15 is set to 40.0 nF, and the capacitance of the second capacitor 16 is set to 45.6 nF. The inductance of the first coil 17 is set to 70.0 μH. Furthermore, the inductance of the transmission coil 14 is set to 160 μH, and the inductance of the receiving coil 21 is set to 80.0 μH. Furthermore, the capacitance of the resonant capacitor 22 is set to 44.8 nF. A winding resistance value on the power transmission side and a winding resistance value on the power receiving side are set to 0.13Ω. Furthermore, a voltage Vin of AC power output by the inverter 13 and applied to the transmission coil 14 is set to 310 V. Graph 201 represents a frequency characteristic of the output voltage when a degree of coupling between the transmission coil 14 and the receiving coil 21 is defined as k=0.11, and an output load resistance value of the load circuit 4 is set to 20Ω. Graph 202 represents a frequency characteristic of the output voltage when the degree of coupling k=0.11, and the output load resistance value of the load circuit 4 is set to 2 kΩ. Furthermore, graph 203 represents a frequency characteristic of the output voltage when the degree of coupling k=0.22, and the output load resistance value of the load circuit 4 is set to 20Ω. Furthermore, graph 204 represents a frequency characteristic of the output voltage when the degree of coupling k=0.22, and the output load resistance value of the load circuit 4 is set to 2 kΩ. As shown in graphs 201 to 204, it is clear that, at a resonant frequency f1 (=84.6 kHz) of the resonant circuit 20 of the power receiving device 3, even if the output load resistance value of the load circuit 4 changes, the output voltage is kept constant. Furthermore, it is clear that, even if the degree of coupling k changes, at the resonant frequency f1, the output voltage has a maximum value in the frequency characteristic, and a variation of the output voltage with respect to a variation of the frequency is more gradual than at other frequencies at which the output voltage has the maximum value. Hence, by setting the drive frequency of the inverter 13 to a frequency within a predetermined frequency range (for example, a range of 0.97*f1 to 1.03*f1) including the resonant frequency f1 of the resonant circuit 20, the non-contact power feeding device 1 is able to perform the constant voltage output operation. Even if a relative positional relationship between the transmission coil 14 and the receiving coil 21 varies and the degree of coupling between these coils changes during power transmission, in the non-contact power feeding device 1, by setting the drive frequency to a frequency within the above predetermined frequency range, power transmission efficiency can be maintained to some extent. Furthermore, even if the degree of coupling between the transmission coil 14 and the receiving coil 21 changes, in the non-contact power feeding device 1, by simply adjusting the voltage of AC power supplied to the transmission coil 14 without changing the drive frequency, the output voltage can be maintained within a constant range.

Next, details of voltage control of AC power supplied from the power supply circuit 10 to the transmission coil 14 by the control circuit 19 of the power transmission device 2 are described.

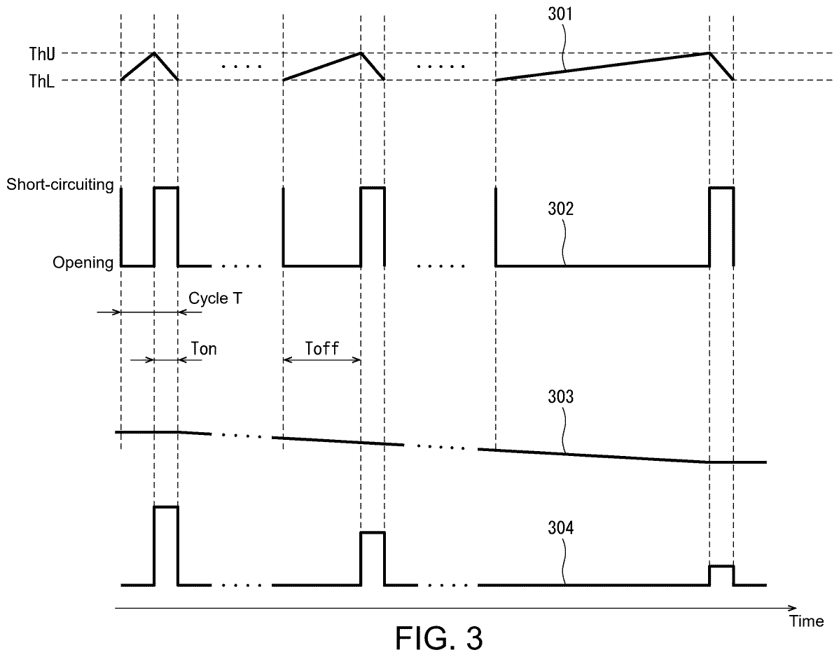

FIG. 3 is a diagram showing an example of a relationship between output voltage, short-circuiting and opening of the resonance suppression coil 25, voltage (hereinafter sometimes referred to as input voltage) of AC power supplied to the transmission coil 14, and the current flowing through the switch circuit 26. In FIG. 3, the horizontal axis represents time. Waveform 301 and waveform 302 represent a time change of the output voltage and a time change of a state of short-circuiting and opening of the resonance suppression coil 25, respectively. Furthermore, waveform 303 represents a time change of the input voltage, and waveform 304 represents a time change of the current flowing through the switch circuit 26.

As shown in waveforms 301 to 303, the lower the input voltage becomes, the longer the time required for the output voltage to rise from a lower limit threshold ThL to an upper limit threshold ThU, that is, an OFF period Toff during which the resonance suppression coil 25 is opened, becomes. If the load of the load circuit 4 is constant, the time required for the output voltage to fall from the upper limit threshold ThU to the lower limit threshold ThL, that is, an ON period Ton during which the resonance suppression coil 25 is short-circuited, is constant. Accordingly, the lower the input voltage becomes, the longer a repetition cycle T (=Toff+Ton) becomes. As a result, a duty ratio D (=Ton/T) related to short-circuiting of the resonance suppression coil 25 is also reduced. As shown in waveform 304, the smaller the duty ratio D becomes, the shorter a ratio of a period during which current flows through the switch circuit 26 in the repetition cycle T becomes. Furthermore, as the input voltage falls, the value of the current flowing through the switch circuit 26 is reduced. Accordingly, the lower the input voltage, the less the loss caused by the current flowing through the resonance suppression coil 25 and the switch circuit 26 while the resonance suppression coil 25 is short-circuited. Hence, it is preferable that the input voltage be controlled to reduce the duty ratio D. However, when the input voltage is excessively lowered, there is a risk that the output voltage may not be able to exceed the lower limit threshold ThL, and the operation of the load circuit 4 may be hindered. Furthermore, when the repetition cycle T becomes excessively long, it becomes difficult to suitably follow the input voltage when a variation occurs in the positional relationship between the transmission coil 14 and the receiving coil 21. Accordingly, it is preferable that the control circuit 19 control the input voltage Vin so that a length of the OFF period Toff is less than a certain length. Accordingly, even if the output voltage is in a state outside the allowable range for reasons such as that a variation occurs in the positional relationship between the transmission coil 14 and the receiving coil 21 during power transmission, the time during which such a state continues is prevented from becoming excessively long.

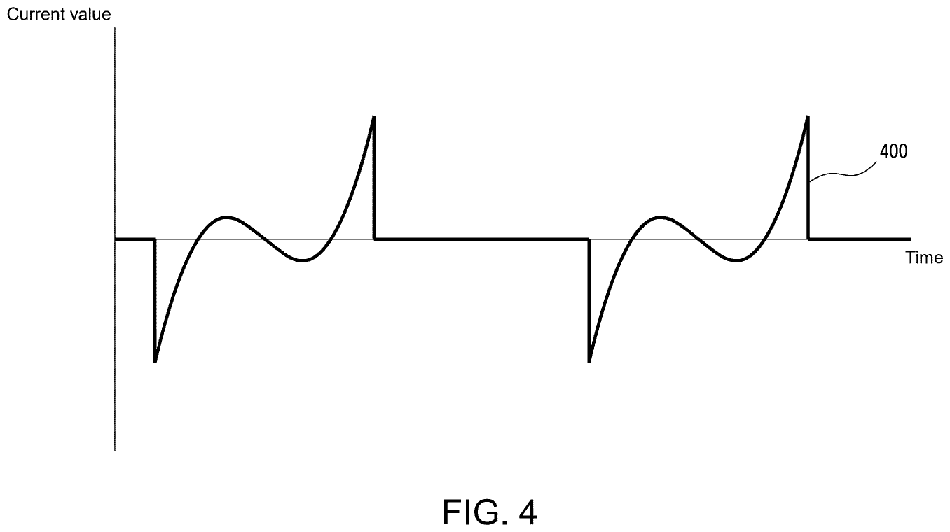

FIG. 4 is a diagram showing an example of a waveform of current flowing through a switching element of the inverter 13 when the resonance suppression coil 25 is short-circuited. In FIG. 4, the horizontal axis represents time, and the vertical axis represents current value. Waveform 400 represents a time change of current flowing through the switching element of the inverter 13.

In the present embodiment, since the power transmission device 2 is provided with, between the power supply circuit 10 and the transmission coil 14, the first coil 17, the first capacitor 15, and the second capacitor 16, waveform 400 includes two poles in a repetition cycle of a current waveform. As a result, it is possible to reduce a peak value of the current waveform, and power loss on the power transmission side is reduced.

According to the above, by controlling the input voltage of AC power supplied from the power supply circuit 10 to the transmission coil 14 based on the duty ratio D, the control circuit 19 is able to keep the output voltage within a constant range and reduce power loss.

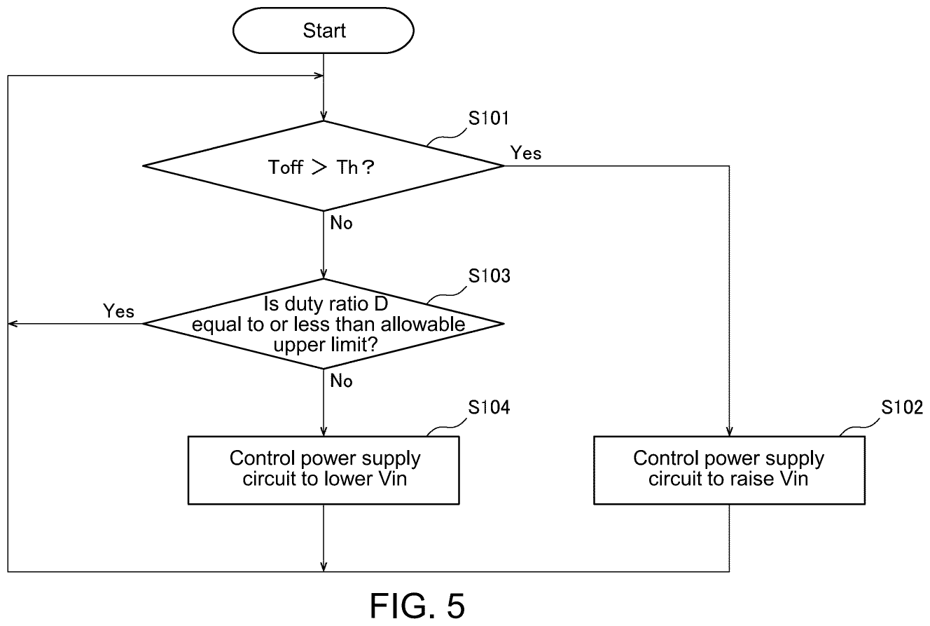

FIG. 5 is an operation flowchart of control of input voltage by the control circuit 19. It is sufficient that the control circuit 19 controls the power supply circuit 10 according to the operation flowchart described below.

The control circuit 19 determines whether a length of the OFF period Toff during which the resonance suppression coil 25 is opened, indicated in the received duty ratio information, is greater than a predetermined threshold Th (for example, 1 sec) (step S101). If the length of the OFF period Toff is greater than the threshold Th (step S101: Yes), the control circuit 19 controls the power supply circuit 10 to raise the input voltage Vin (step S102). In the present embodiment, the control circuit 19 increases a duty ratio of a switching element of the power factor correction circuit 12. Accordingly, it is expected that the OFF period Toff is shortened and that the duty ratio D is increased due to the shortening of the OFF period Toff. The control circuit 19, after receiving the next duty ratio information, repeats the processing in and after step S101.

On the other hand, if the length of the OFF period Toff is equal to or less than the threshold Th (step S101: No), the control circuit 19 determines whether the duty ratio D related to short-circuiting of the resonance suppression coil 25, indicated in the received duty ratio information, is equal to or less than a preset allowable upper limit value (step S103). As described above, since a smaller duty ratio D is preferable, the allowable upper limit value for the duty ratio D is preferably set to 0.3 or less, preferably 0.2 or 0.15.

If the duty ratio D is equal to or less than the allowable upper limit value (step S103: Yes), the control circuit 19 does not change the duty ratio of the switching element of the power factor correction circuit 12. That is, the input voltage Vin of AC power supplied from the power supply circuit 10 to the transmission coil 14 is maintained as is. The control circuit 19, after receiving the next duty ratio information, repeats the processing in and after step S101. On the other hand, if the duty ratio D is greater than the allowable upper limit value (step S103: No), the control circuit 19 controls the power supply circuit 10 to lower the input voltage Vin of AC power supplied from the power supply circuit 10 to the transmission coil 14 (step S104). In the present embodiment, the control circuit 19 decreases a duty ratio of a switching element of the power factor correction circuit 12. Accordingly, it is expected that the duty ratio D is reduced due to the lengthening of the OFF period Toff. The control circuit 19, after receiving the next duty ratio information, repeats the processing in and after step S101.

When the communication unit 18 becomes unable to receive a wireless signal from the communication unit 27, it is assumed that the power receiving device 3 has moved to a position where it does not receive power from the power transmission device 2. Accordingly, the control circuit 19 may lower the voltage Vin to a predetermined standby voltage value. The standby voltage value is set to a value lower than an input voltage during normal power transmission.

As described above, in the non-contact power feeding device, by providing the resonance suppression coil for suppressing resonance of the resonant circuit in the power receiving device, and switching between short-circuiting and opening of the resonance suppression coil, even if the degree of coupling between the coil on the power transmission side and the coil on the power receiving side varies during power transmission, the output voltage can be kept within a constant range. Furthermore, in the non-contact power feeding device, by controlling the input voltage of AC power supplied to the coil for power transmission based on the duty ratio related to short-circuiting of the resonance suppression coil, power loss when the resonance suppression coil is short-circuited can be reduced. As a result, the non-contact power feeding device can be

When the load of the load circuit 4 is reduced, a fall in output voltage when the resonance suppression coil 25 is short-circuited becomes gradual.

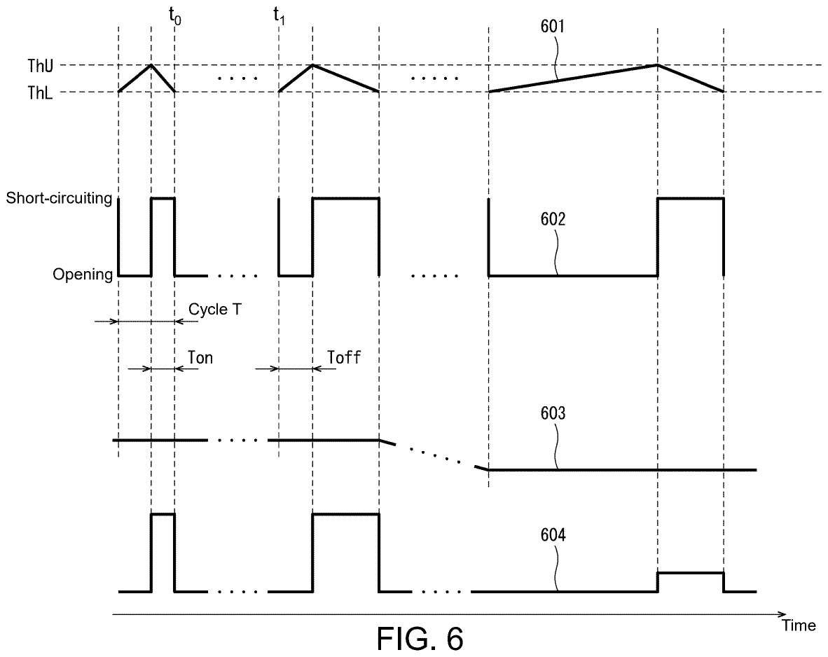

FIG. 6 is a diagram showing an example of a relationship between output voltage, short-circuiting and opening of the resonance suppression coil 25, input voltage, and current flowing through the switch circuit 26 in the case where the load of the load circuit 4 has fluctuated. In FIG. 6, the horizontal axis represents time. Waveform 601 and waveform 602 represent a time change of the output voltage and a time change of a state of short-circuiting and opening of the resonance suppression coil 25, respectively. Furthermore, waveform 603 represents a time change of the input voltage, and waveform 604 represents a time change of the current flowing through the switch circuit 26.

In this example, the load of the load circuit 4 is reduced between time t0 and time t1. As the load is reduced, as shown in waveform 601 and waveform 602, a fall in output voltage becomes gradual, and the ON period Ton becomes longer. As a result, the period during which current flows through the switch circuit 26 becomes longer, and there is a possibility that a heat generation amount of the switch circuit 26 may excessively increase.

Accordingly, according to a modification, the control circuit 19 controls the voltage of AC power supplied from the power supply circuit 10 to the transmission coil 14 according to the temperature of the switch circuit 26.

Referring again to FIG. 1, in this modification, as shown by a dotted line, in the power receiving device 3, a thermometer 30 for measuring the temperature of the switch circuit 26 is provided in the vicinity of the switch circuit 26. A measured value of the temperature obtained by the thermometer 30 is output to the switch control circuit 28. The switch control circuit 28 includes the measured value of the temperature in duty ratio information, and notifies the duty ratio information to the power transmission device 2 via the communication unit 27.

The control circuit 19 of the power transmission device 2 compares the measured value of the temperature included in the duty ratio information received via the communication unit 18 with a predetermined temperature threshold. In the case where the measured value of the temperature is higher than the temperature threshold, the duty ratio of the switching element of the power factor correction circuit 12 of the power supply circuit 10 is controlled so that the input voltage of AC power supplied from the power supply circuit 10 to the transmission coil 14 falls to the predetermined standby voltage value.

After lowering the input voltage to the standby voltage value, when the measured value of the temperature included in the duty ratio information received from the power receiving device 3 is reduced to the temperature threshold or less, it is sufficient that the control circuit 19 again controls the power supply circuit 10 and the input voltage according to the operation flowchart shown in FIG. 5.

In the case where the measured value of the temperature is higher than the temperature threshold, the control circuit 19 may control the power supply circuit 10 to remove a restriction that the length of the OFF period Toff is equal to a certain length or less and lower the input voltage Vin. That is, the control circuit 19 may lower the input voltage Vin until the measured value of the temperature becomes equal to or less than the temperature threshold.

According to this modification, in the non-contact power feeding device, since heat generation of the switch circuit 26 can be suppressed, even if the load of the load circuit 4 is reduced, power transmission can be safely continued.

The switch control circuit 28 of the power receiving device 3 may perform comparison between the measured value of the temperature and the temperature threshold. The switch control circuit 28 may include a comparison result instead of the measured value of the temperature in the duty ratio information. In this case, it is sufficient that the control circuit 19 of the power transmission device 2 controls the power supply circuit 10 and input voltage in the same manner as the above processing based on the comparison result between the measured value of the temperature included in the received duty ratio information and the temperature threshold.

In the resonant circuit 20 of the power receiving device 3, the receiving coil 21 and the resonant capacitor 22 may be connected in parallel with each other so as to resonate in parallel. Furthermore, in the power receiving device 3, another coil connected in series with the receiving coil 21 may be provided between the resonant circuit 20 and the rectifier smoothing circuit 23. In the case where a variation in the positional relationship between the power transmission device 2 and the power receiving device 3 is negligible during power transmission, the first coil 17 and the second capacitor 16 may be omitted in the power transmission device 2.

Furthermore, the power supply circuit 10 of the power transmission device 2 may include, instead of the power factor correction circuit 12, a DC-DC converter having a variable step-up/step-down ratio. DC power may be directly input to the DC-DC converter. Similarly to the above embodiment, by controlling the step-up/step-down ratio of the DC-DC converter according to the duty ratio related to short-circuiting of the resonance suppression coil 25, the control circuit 19 may control the input voltage of AC power supplied from the power supply circuit 10 to the transmission coil 14.

The non-contact power feeding device according to the above embodiment or modification is suitably utilized in power supply to a moving body such as an automatic guided vehicle (AGV).

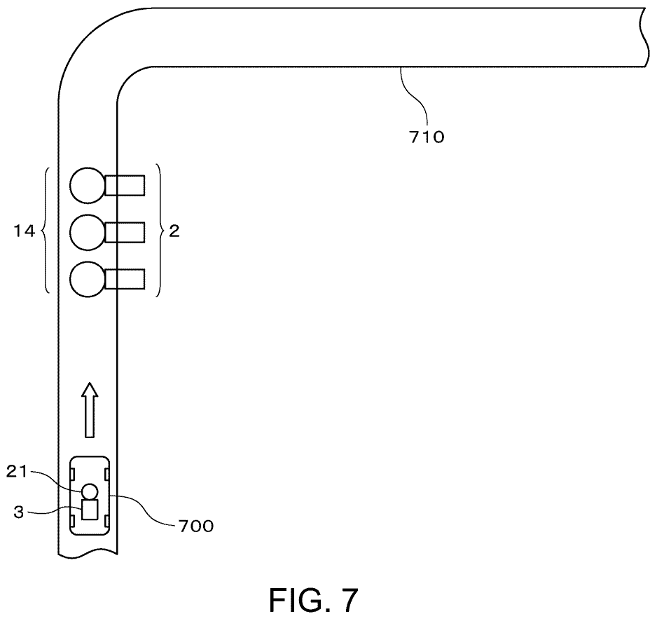

FIG. 7 is an overview diagram in the case where the non-contact power feeding device according to the above embodiment or modification is utilized as a power supply system for a moving body. The power receiving device 3 is mounted on a moving body 700. On the other hand, the power transmission device 2 is arranged along a movement path of the moving body 700. For example, the transmission coil 14 is installed on a floor surface on a movement path 710 of the moving body 700. The transmission coil 14 is preferably provided at a position where the moving body 700 temporarily stops, or at a position where a movement speed of the moving body 700 becomes a predetermined speed or less. On the other hand, the receiving coil 21 is mounted to face the floor surface in a lower part of the moving body. The number of the power transmission device 2 is not limited to one. Multiple power transmission devices 2 may be installed at mutually different positions on the movement path 710. In the example shown in FIG. 7, three power transmission devices 2 are illustrated. The transmission coils 14 of the power transmission devices 2 are arranged in a line along an extension direction of the movement path 710. In the case where multiple power transmission devices 2 are installed, the transmission coils 14 of the power transmission devices 2 may be arranged in a direction orthogonal to the extension direction of the movement path 710, or may be arranged in a grid pattern or staggered pattern.

When the moving body 700 passes through a position where the transmission coil 14 of any of the power transmission devices 2 is provided, the transmission coil 14 and the receiving coil 21 become able to be electromagnetically coupled, and power is transmitted from the power transmission device 2 to the power receiving device 3. The power received by the power receiving device 3 is used to operate various devices mounted on the moving body 700 or to operate the moving body 700 itself. At that time, it is sufficient that the control circuit 19 controls the input voltage of AC power supplied from the power supply circuit 10 to the transmission coil 14 according to the above embodiment or modification. Accordingly, even if the moving body 700 moves during power transmission, the power transmission device 2 is able to transmit power, with high power transmission efficiency, to the power receiving device 3 mounted on the moving body 700.

In this way, those skilled in the art may make various modifications within the scope of the present invention according to the embodiment to be implemented.

### DESCRIPTION OF REFERENCE NUMERALS

1: non-contact power feeding device
2: power transmission device
10: power supply circuit
11: full-wave rectifier circuit
12: power factor correction circuit
13: inverter
13-1 to 13-4: switching element
14: transmission coil
15: first capacitor
16: second capacitor
17: first coil
18: communication unit
19: control circuit
3: power receiving device
20: resonant circuit
22: resonant capacitor
23: rectifier smoothing circuit
24: voltage detection circuit
25: resonance suppression coil
26: switch circuit
27: communication unit
28: switch control circuit
30: thermometer
4: load circuit
700: moving body

1. A non-contact power feeding device, comprising a power transmission device and a power receiving device to which power is transmitted from the power transmission device in a non-contact manner, wherein
the power transmission device comprises:
a transmission coil, supplying power to the power receiving device;
a power supply circuit, supplying AC power to the transmission coil;
a first communication unit, capable of communicating with the power receiving device; and
a control circuit, controlling a voltage of AC power supplied from the power supply circuit to the transmission coil;
the power receiving device comprises:
a resonant circuit, comprising a receiving coil and a resonant capacitor connected to the receiving coil, the resonant circuit receiving power from the transmission coil by resonating with current flowing through the transmission coil of the power transmission device;
a rectifier circuit, rectifying power received via the resonant circuit;
a voltage detection circuit, measuring an output voltage of power output from the rectifier circuit;
a resonance suppression coil, arranged to be able to be electromagnetically coupled with the receiving coil;
a switch circuit, connected to the resonance suppression coil and capable of switching between short-circuiting and opening of the resonance suppression coil;
a second communication unit, capable of communicating with the power transmission device; and
a switch control circuit, controlling the switch circuit to short-circuit the resonance suppression coil in response to a measured value of the output voltage becoming equal to or greater than a predetermined upper limit threshold, controlling the switch circuit to open the resonance suppression coil in response to the measured value of the output voltage becoming equal to or less than a predetermined lower limit threshold that is lower than the predetermined upper limit threshold, obtaining a duty ratio related to a period during which the resonance suppression coil is short-circuited, and causing the second communication unit to transmit the duty ratio;
the control circuit of the power transmission device controls the voltage of AC power supplied from the power supply circuit to the transmission coil so that the duty ratio received via the first communication unit falls within a predetermined allowable range.

2. The non-contact power feeding device according to claim 1, wherein
the power transmission device further comprises:
a first capacitor, connected between the power supply circuit and one end of the transmission coil;
a first coil, connected between the power supply circuit and one end or an other end of the transmission coil and the power supply circuit; and
a second capacitor, having one end connected to the first capacitor and an other end connected to an other end of the transmission coil;
a frequency of AC power supplied from the power supply circuit to the transmission coil is set to be included in a predetermined frequency range that includes a resonant frequency of the resonant circuit of the power receiving device.

3. The non-contact power feeding device according to claim 1, wherein
in a case where a period during which the resonance suppression coil of the power receiving device is opened is longer than a predetermined threshold, the control circuit of the power transmission device controls the power supply circuit to raise the voltage of AC power supplied from the power supply circuit to the transmission coil, and in a case where the duty ratio is greater than an upper limit of the predetermined allowable range and the period during which the resonance suppression coil is opened is equal to or shorter than the predetermined threshold, the control circuit of the power transmission device controls the power supply circuit to lower the voltage of AC power supplied from the power supply circuit to the transmission coil.

4. The non-contact power feeding device according to claim 3, wherein
the power receiving device further comprises a thermometer that measures a temperature of the switch circuit;
the control circuit of the power transmission device, in response to the temperature measured by the thermometer exceeding a predetermined temperature threshold, lowers the voltage of AC power supplied from the power supply circuit to the transmission coil to a predetermined standby voltage.

5. The non-contact power feeding device according to claim 1, wherein
the power receiving device is mounted on a moving body, and the transmission coil of the power transmission device is installed on a movement path of the moving body.

6. The non-contact power feeding device according to claim 2, wherein
in a case where a period during which the resonance suppression coil of the power receiving device is opened is longer than a predetermined threshold, the control circuit of the power transmission device controls the power supply circuit to raise the voltage of AC power supplied from the power supply circuit to the transmission coil, and in a case where the duty ratio is greater than an upper limit of the predetermined allowable range and the period during which the resonance suppression coil is opened is equal to or shorter than the predetermined threshold, the control circuit of the power transmission device controls the power supply circuit to lower the voltage of AC power supplied from the power supply circuit to the transmission coil.

7. The non-contact power feeding device according to claim 2, wherein
the power receiving device is mounted on a moving body, and the transmission coil of the power transmission device is installed on a movement path of the moving body.
